(19) United States
(12) Patent Application Publication
(10) Pub. No.: US 2007/0047424 A1
(43) Pub. Date: Mar. 1, 2007

(54) Objective lens unit, its manufacturing method and optical pick-up apparatus

(75) Inventors: Kazuhiro Wada, Tokyo (JP); Keisuke Kikuchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/508,862

(22) Filed: Aug. 24, 2006

(30) Foreign Application Priority Data
Aug. 29, 2005 (JP) JP2005-248304
Aug. 29, 2005 (JP) JP2005-248305
Sep. 6, 2005 (JP) JP2005-257923

(51) Int. Cl. G11B 7/00; G11B 7/135

(52) U.S. Cl. 369/112.23

(57) ABSTRACT

An integral type objective lens unit which has the first lens part used for the first wavelength light, and the second lens part used for the second wavelength light whose wavelength is different from the first wavelength, and in which the first lens part and the second lens part are arranged in adjoining manner, and the objective lens unit for the optical pick-up apparatus in which, on the optical surface of the first lens part and the optical surface of the second lens part, a common reflection prevention film adopted for the light having the first wavelength and the light having the second wavelength is provided.

The present application is based on Japanese Patent Application No. 2005-248304 filed on Aug. 29, 2005, Japanese Patent Application No. 2005-248305 filed on Aug. 29, 2005 and Japanese Patent Application No. 2005-257923 filed on Sep. 6, 2005, the contents of which are incorporated herein by reference.

### FIELD OF THE INVENTION

The present invention relates to an objective lens unit that is adequate as an objective system for an optical pick-up, and its manufacturing method, further, to an optical pick-up apparatus having such an objective lens unit.

### BACKGROUND OF THE INVENTION

Heretofore, each kind of optical pick-up apparatus by which the reproduction and/or recording of the information is conducted for the optical information recording medium such as CD(compact disk), DVD (direct versatile disk) is developed and manufactured, and spread in common. As an objective lens unit assembled in such an optical pick-up apparatus, there exists a composite objective lens in which a plurality of lens elements are inserted into a holder and fixed, and to different kind of recording media, the reproducing and recording of the information can be easily conducted (Refer to Patent Document 1). Further, as the similar objective lens, there also exists a composite objective lens in which a plurality of lens elements are combined is integrally molded, in this case, the composite objective lens is size-reduced by the integral molding and an assemble process also becomes simple (Refer to Patent Documents 2-5). Further, there exists also an objective lens that is formed in such a manner that two micro-lenses, whose focal distances are different from each other, are entered into the glass substrate whose refractive index is relatively low (Refer to Patent Document 6). Further, a technology that a reflection prevention film for preventing the reflection of a light flux of a plurality of wavelengths is provided in the objective lens assembled in the optical pick-up apparatus by which the information can be reproduced and recorded to a different kind recording medium, is disclosed in Patent Document 7.

[Patent Document 1] JP-A No. 2001-67700 (Hereinafter, JP-A refers to Japanese Patent Publication Open to Public Inspection)

[Patent Document 2] JP-A No. 9-115170

[Patent Document 3] JP-A No. 9-396912

[Patent Document 4] JP-A No. 10-275356

[Patent Document 5] JP-A No. 9-63083

[Patent Document 6] JP-A No. 2000-90402

[Patent Document 7] JP-A No. 2005-38581

However, in the composite lens in which a plurality of lens elements are inserted into the holder and fixed, the size of the objective lens is increased and the assembling process tend to be complicated, and particularly, the aligning between the plurality of lenses becomes difficult.

On the one hand, in the case of the composite objective lens in which a plurality of lens elements are integrated and integrally molded, the objective lens is easily comparatively downsized, and the assembling process is simple, resulting in cost reduction. In Patent Documents 1-6, composite lenses are disclosed, however, there is no disclosure for the formation of the reflection prevention film. In the case where the reflection prevention film is formed on such a composite lens, it is considered that individual reflection prevention film appropriate for respective using wavelength is formed on the optical surface of each lens element that is closely arranged. However, it is not easy that the individual reflection prevention film is formed on the optical surface of each lens element closely arranged. Actually, a manufacturing method in which while one hand lens element is protected by the mask, one multi-layer film is formed on the optical surface of the other hand lens element, and while the other hand lens element is protected by the mask, the other multi-layer film is formed on the optical surface of the one hand lens element, is used. Herein, in the case of the mask whose shield is assured, the replace of the mask is not easy, and in the case of the mask whose replacement is easy, the possibility that unnecessary component when the film formation is conducted on the one hand lens, is adhered to the other hand lens element, is enhanced.

Further, in the case of the objective lens formed in such a manner that two micro-lenses are put into a glass substrate whose refractive index is relatively low, the manufacturing process is very complicated, and the degree of the freedom of the optical characteristic which can be set to the resultantly obtained objective lens is also limited. Further, it is not easy to form the individual reflection prevention films on the optical surface of each micro-lens.

### SUMMARY OF THE INVENTION

An object of the invention is to provide an objective lens unit for an optical pick-up apparatus used for a compatible purpose whose size is small and by which the high accurate image formation can be conducted, and the simple and low cost reflection prevention can be realized.

Further, object of the present invention is to provide a compatible optical pick-up apparatus by which the low cost and high reproducing and/or recording accuracy is realized.

Still further object of the present invention is to provide a manufacturing method of the objective lens unit by which simple and low cost reflection prevention is realized.

In order to solve the above-described objects, the objective lens unit for the optical pick-up apparatus according to the present invention is provided with the first lens part which is used in the light having the first wavelength, and the second lens part which is used in the light having the second wavelength different from the first wavelength, and an integral objective lens unit in which the first lens part and the second lens part are arranged in an adjoining manner, that is side-by-side arrangement, and a common reflection prevention film adequate for both the light having the first wavelength and the light having the second wavelength is provided on an optical surface of the first lens part and an optical surface of the second lens part.

Because the above objective lens unit is an integral one (integral molding) in which the objective lens is formed in such a manner that the first lens part and the second lens part are arranged in the adjoining manner, the reproducing and/or recording can be simply conducted to the 2 kinds of optical information recording media whose standard is different, depending on arranging which one of the first and the second lens part on the optical path. Furthermore, in the case of the present objective lens unit, because the common reflection prevention film adequate for both the light having the first wavelength and the light having the second wavelength is provided on the optical surface of the first lens part and the optical surface of the second lens part, the reflection prevention film can be formed collectively on the first lens part and the second lens part. Hereby, in spite of that the first lens part and the second lens part are adjoined, the high accurate reflection prevention film can be formed on the both comparatively simply and in low cost.

Further, in the specific embodiment or viewpoint of the present invention, in the above objective lens unit, a connection part by which the first lens part and the second lens part are mutually positioned and held is further provided with. In this case, when the objective lens unit is manufactured or used, the first lens part and the second lens part can be supported in a appropriate condition while avoiding the interference of the both. Hereupon, also in this case, the first lens part and the connection part and the second lens part are formed by integral molding.

In another embodiment of the present invention, the first wavelength is within the range of 390-420 nm. In this case, by the first lens part, the reproducing and/or recording of the information can be conducted with the high density by using the near-ultraviolet or blue light. Hereupon, this wavelength range includes the wavelength corresponding to the standard of the BD (Blue ray•Disk) or HD-DVD.

In yet another embodiment of the present invention, the second wavelength is within the range of 630-680 nm. In this case, by the second lens part, the reproducing and/or recording of the information can be conducted by using the red light. Hereupon, this wavelength range includes the wavelength corresponding to the standard of DVD.

In yet further embodiment of the present invention, the second wavelength is within the range of 670-800 nm. In this case, by the second lens part, the reproducing and/or recording of the information can be conducted by using the light having the near-infrared. Hereupon, this wavelength range includes the wavelength corresponding to the standard of CD.

Hereupon, the objective lens unit can be formed of various resins generally usable for the optical purpose such as lens. Particularly, it is preferable that the resin including the polymer having the alicyclic structure is used, and in them, it is more preferable that cyclic olefin rein is used.

Further, as the material of the above described resin, athermal resin can be used. The athermal resin is a material in which, in the resin of base material, the particle whose diameter is, for example, less than 30 nm, is dispersed. Because the athermal resin has the characteristic that refractive index change to the temperature change is smaller than the general optical purpose resin, when the phase structure is formed in the first lens part or the second lens part, the improving effect of the temperature characteristic by the phase structure can be made moderate, thereby, the deterioration of the wavelength characteristic by the phase structure can be reduced, the degree of freedom of the design of the optical element can be expanded, or the allowable range of the manufacturing error or the assembling accuracy can be expanded.

Generally, when the powder is mixed in the transparent resin material, because the scattering of the light is generated, and the transmission rate is lowered, it is difficult that the material is used as the optical material, however, when the fine powder is made such that the fine particle whose average particle diameter is for example less than 30 nm which is smaller than the wavelength of the transmission light flux, it has been found that the scattering can be made not to generate in fact. When such a phenomenon is used, the material whose temperature characteristic is different, can be uniformly mixed in a broad view, and it can be suppressed that the temperature change of the refractive index or basic thermal expansion becomes conspicuous, and the material to which such a human-induced temperature characteristic suppression effect is given, is called the athermal resin. As athermal resin, the material is preferable in which the fine particle whose average particle diameter having the refractive index change rate larger than the refractive index change rate following the temperature change of the resin as the base material, is less than 30 nm, is dispersed. Hereupon, “the refractive index change rate is large” includes, when a sign of the refractive index change rate of the resin as the base material, is negative, both of the material having the negative refractive index change rate which is closer to zero than the value and the material having the negative refractive index change rate, and the material having the positive refractive index change rate.

In yet further embodiment of the present invention, a holder for directly or indirectly supporting at least one of the first lens part and the second lens part is further provided. In this case, the first lens part and the second lens part can be displaced through the holder, and the facilities of drive of the objective lens unit or handling thereof can be extended.

The optical pick-up apparatus according to the present invention is provided with (a) the above objective lens unit, and (b) the optical apparatus by which, through the first lens part, the information of the first optical information recording medium is read, or, the information is written in the first optical information recording medium, and through the second lens part, the information of the second optical information recording medium is read, or, the information is written in the second optical information recording medium.

In the above optical pick-up apparatus, the above objective lens unit is used, and the reproducing and/or recording of the information can be easily conducted on the first and second optical information recording medium whose standards are different from each other. Further, the common reflection prevention film provided on the first lens part and second lens part is manufactured comparatively simply and in low cost, however, in spite of that, as a result of collective film formation, it is comparatively high performance one, and the reproducing and/or recording of the information can be high accurately conducted.

In the specific embodiment of the present invention, in the above optical pick-up apparatus, a drive device by which the objective lens unit is driven, and the first and second lens parts are displaced, is further provided. In this case, the switching between the first and second lens parts becomes possible, and tracking or focusing becomes possible for each lens part.

The manufacturing method of the objective lens unit according to the present invention is the manufacturing method of the integral type objective lens unit in which the first lens part used for the light having the first wavelength and the second lens part used for the light having the second wavelength different from the first wavelength, are arranged in an adjoining manner, and is characterized in that: a common reflection prevention film adequate for both the light having the first wavelength and the light having the second wavelength is collectively film-formed on the optical surface of the first lens part and the optical surface of the second lens part.

In the above manufacturing method of the objective lens unit, because a common reflection prevention film adequate for the both can be collectively provided on the optical surface of the first lens part and the optical surface of the second lens part, and in spite of that the first lens part and the second lens part are adjoined, for both, the high accurate reflection prevention film can be formed comparatively simply and in low cost. Accordingly, when this objective lens unit is assembled in the optical pick-up apparatus, the reproducing and/or recording of the information can be high accurately conducted on the first and the second optical information recording medium whose standard is different.

### BRIEF DESCRIPTION OF THE DRAWINGS

FIG. 1 (a) is a front view of an objective lens unit of the first embodiment, FIG. 1 (b) is a side view of the objective lens unit, and FIG. 1 (c) is a side view of a composite objective lens of the objective lens unit.

FIG. 2 (a) and FIG. 2 (b) are partially enlarged sectional views for explaining a reflection prevention film formed on the objective lens unit shown in FIG. 1.

FIG. 3 is a view illustrating a film formation apparatus of the reflection prevention film shown in FIG. 2.

FIG. 4 is a view showing a structure of an optical pick-up apparatus in which the objective lens unit shown in FIG. 1 is mounted.

FIG. 5 is a plan view showing the structure of the objective lens unit of the second embodiment.

FIG. 6 is a plan view showing the structure of the optical pick-up apparatus of the third embodiment.

FIG. 7 is a plan view showing the structure of the objective lens unit of the fourth embodiment.

FIG. 8 is a plan view showing the structure of the objective lens unit of the fifth embodiment.

FIG. 9 is a view showing the structure of the optical pick-up apparatus of the sixth embodiment.

FIG. 10 (a) is a front view of an objective lens unit of the seventh embodiment, FIG. 10(b) is a side view of the objective lens unit and FIG. 10 (c) is a side view of a composite objective lens.

### DETAILED DESCRIPTION OF THE PREFERRED EMBODIMENTS

### The First Embodiment

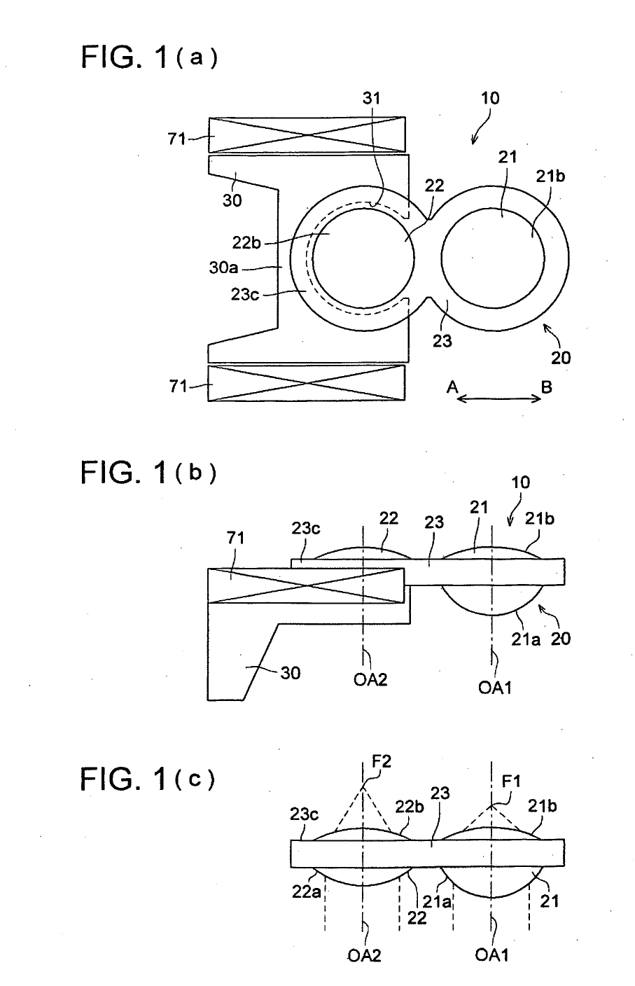

Referring to the drawings, an objective lens unit according to the first embodiment of the present invention will be described below. Hereupon, FIG. 1(a) and FIG. 1(b) are a front view and side view of an objective lens unit of the first embodiment, and FIG. 1 (c) is a side view of a composite objective lens constituting the objective lens unit.

An objective lens 10 shown in FIG. 1(a) has a composite objective lens 20 which is the objective lens system arranged in opposite to the optical disk (not shown), a holder member 30 which supports this composite objective lens 20 and is displaced with it, and two actuator parts 71 which are composed of coils, and fixed to a side surface of the holder member 30.

The composite objective lens 20 includes the first lens part 21 which can converge the incident light on the information recording surface provided in the optical disk, not shown, with a comparatively small spot diameter, and the second lens part 22 which can converge the incident light on the information recording surface provided in another type optical disk with a comparatively large spot diameter. Both lens parts 21, 22 are supported and fixed from the periphery by a connection part 23, and arranged in an adjoining condition almost along to the specific surface (the surface parallel to the paper surface in FIG 1(a)) perpendicular to each of optical axes OA1, and OA2. The composite objective lens 20 is a single component formed of various kinds of materials such as plastic, and the fist lens part 21 and the second lens part 22 are integrated through the connection part 23.

The lens part 21 is designed for use with the first laser light having wavelength 405 nm as the first wavelength λ1, that is, for BD. That is, as shown in FIG. 1(c), when the light flux of the first laser light having wavelength 405 nm parallel to the optical axis OA1 is incident on the first optical surface 21a of the first lens part 21 from its side, for example, along the optical axis OA1, the laser light flux is projected from the second optical surface 21b side of the first lens part 21, and this laser light flux is converged at the focal position F1 on the optical axis OA1, and forms a comparatively small light converging spot here.

The second lens part 22 is designed for use with the second laser light having the wavelength 655 nm as the second wavelength λ2, that is, for DVD. That is, as shown in FIG. 1(c), when the light flux of the second laser light having wavelength 655 nm parallel to the optical axis OA2 is incident on the first optical surface 22a of the second lens part 22 from its side, for example, along the optical axis OA2, the laser light flux of the wavelength 655 nm is projected from the second optical surface 22b side of the second lens part 22, and this laser light flux is converged at the focal position F2 on the optical axis OA2, and forms a comparatively large light converging spot here.

The material for manufacturing the composite objective lens 20 including the first and the second lens parts 21, 22 will be described below. That is, the composite objective lens 20 can be formed of plastic material that can be generally used for the optical application. As a plastic material, for example, there are transparent resin materials such as acrylic resin, polycarbonate resin, poly olefin resin (Geonex resin made by Nippon Zeon co), cyclic olefin co-polymer resin. Further, as glass material, well-known optical glass, for example, M-BaCD5N (trade name, made by Hoya Co.) is used.

Further, as the material for the composite objective lens 20, athermal resin can be used. Athermal resin is a material in which in resin material as base material, for example, particle whose size is lass than 30 nm is dispersed. Generally, in the resin material as the base material, when the temperature rises, refractive index is lowered, however, when the inorganic particle is dispersed and mixed, the refractive index change as whole material can be lowered.

When athermal resin is used, the refractive index change which has been about −1.2×10⁻⁴ in the past can be controlled less than 8×10⁻⁵ in absolute value, however, when refractive index change is further controlled to less than 6 ×10⁻⁵ in absolute value, the performance of the composite objective lens 20 can be more enhanced.

Further preferably, the refractive index change is less than 4×10⁻⁵ in absolute value. There is provided an optical element having no temperature dependency of the refractive index, or very low temperature dependency, by using such resin material as the material of the composite objective lens 20, that the inorganic particles whose size is 30 nm or less, preferably is 20 nm or less, more preferably, 10-15 nm is dispersed in the resin material as base material of the composite objective lens, where the inorganic particles have the refractive index characteristic of inclination in which the refractive index change of the base material is cancelled out.

Further, it is preferable that the fine particle dispersed in the base material is inorganic substance, and further, oxide, and the oxide is further preferable whose oxidation condition is saturated, and which is not oxidized more than that.

Inorganic substance is preferable from a view point that the reaction to resin which is high polymer organic chemical and base material, is suppressed low, further, because it is oxide, deterioration following the actual use such as the laser light irradiation, can be prevented. Particularly, under the high temperature, or under a severe condition that the laser light is irradiated, oxidation of resin is easily accelerated, however, when the minute particle of such an inorganic oxide is applied, deterioration due to oxidation can be prevented.

Further, in order to prevent the oxidation of resin due to other factors, of course, antioxidant can be added to the resin material.

As a specific example of athermal resin, for example, in acrylic resin, the minute particle of niobium oxide (Nb₂O₅) is dispersed. In volume ratio, resin as the base material is 80, niobium oxide is about 20 as the ratio, and they are uniformly mixed. There is a problem that the fine particle is easily flocculated, however, by the engineering that the electric charge is given to the particle surface and it is dispersed, necessary dispersion condition can be generated. Instead of niobium oxide, fine particle of silicon oxide (SiO₂) may also be used.

It is preferable that the process of mixing and dispersing is conducted in in-line at the time of the injection molding of composite objective lens 20. In other word, after mixing and dispersing, it is preferable that, up to the time of completion of molding of the composite objective lens 20, it remains so as not to be cooled and solidified.

Hereupon, the above volumetric ratio can be appropriately increased or decreased so that the ratio of change to the temperature of the refractive index is controlled, and a plurality of kinds of fine particles can be blended and dispersed. That is, in the above example, the volumetric ratio is 80:20, that is, 4:1, however, it can be appropriately adjusted between from 90:10 (9:1) to 60:40 (3:2). When an amount of fine particle is increased more than 9:1, the temperature change suppression effect is increased, and when an amount of the fine particle is decreased less than 3:2, there is no case that problem is generated in the moldability of the optical element, and so it is preferable.

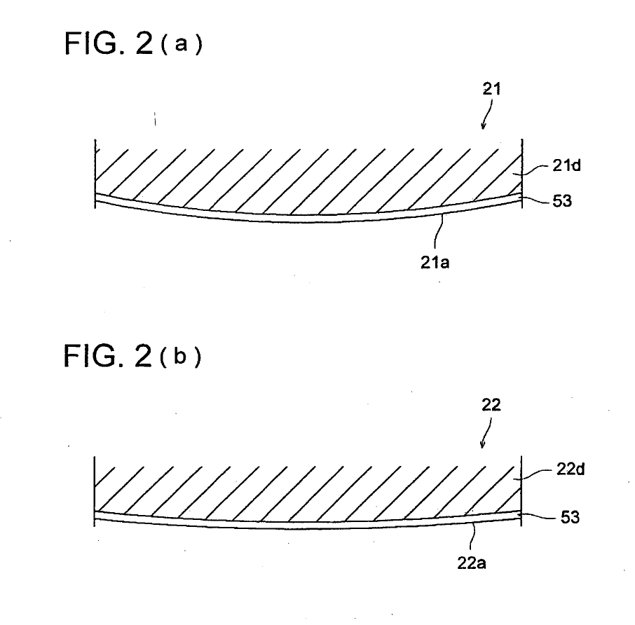

On the first and second lens parts 21, 22, in spite of that the object wavelengths are different, the common reflection prevention film is formed. That is, as shown in FIG. 2(a), on the surface of lens main body 21d of the first lens part 21, a reflection prevention coat (reflection prevention film) 53 having the reflection prevention function for both of the first laser light having wavelength λ1=405 nm, and the second laser light having wavelength λ2=655 nm, is provided, and structures the first optical surface 21a of the first lens part 21. Further, as shown in FIG. 2(b), also on the surface of the lens main body 22d of the second lens part 22, the reflection prevention coat (reflection prevention film) 53 having the reflection prevention function for both of the first laser light having wavelength λ1=405 nm, and the second laser light having wavelength λ2=655 nm, is provided, and structures the first optical surface 22a of the second lens part 22.

Hereupon, the reflection prevention coat 53 is not strictly limited to the first laser light having wavelength 405 nm, but it can prevent the reflection for the laser light whose central wavelength is any one within the range of wavelength λ1=390-420 nm.

The above-description is the description about the first optical surfaces 21a, 22a side of the first and the second lens parts 21, 22, however, also on the second optical surfaces 21b, 22b side of the first and the second lens parts 21, 22, the same film formation can be conducted.

The reflection prevention coat 53 is formed by laminating a plurality of material layers, and both laser light each having the first and the second wavelengths λ1, λ2 respectively, are transmitted with low loss by the interference action of each layer. When these plural layers are made, each layers are named first layer, second layer, third layer, fourth layer and fifth layer in the order closest to the surface of lens main bodies 21d, 22d, the first layer is formed of low refractive index material, the second layer is formed of high refractive index material, the third layer is formed of middle refractive index material, the fourth layer is formed of low refractive index material, the fifth layer is formed of middle refractive index material. In the film thickness of these layers, the first layer is 81.2˜113 nm, the second layer is 108.7˜153 nm, the third layer is 97.6˜136 nm, the fourth layer is 21.6 ˜30 nm, the fifth layer is 71.0˜99.0 nm.

Hereupon, as the high refractive index material, for example, selenium oxide, titanium oxide, tantalum oxide, zirconium oxide, aluminum oxide, silicon nitride and silicon nitride including oxygen are listed. Further, as the middle refractive index material, for example, aluminum oxide, yttrium oxide, lead fluoride, cerium fluoride are listed. Further, as the low refractive index material, for example, there are silicon oxide, magnesium fluoride, aluminum fluoride, crystal-stone. Hereupon, when using only one kind of these materials, a layer formed of single component may also be structured, or when a plurality of kinds of materials are used, a layer formed of plural components may also be structured, further, as a case where a plurality of kinds of materials are used, there is a case where mixture are made evaporation materials, or a case where separate materials are made simultaneously evaporation material.

The structure of the reflection prevention coat 53 as described above, is simply an exemplification, and the film thickness or number of layers can be appropriately changed so that the wavelength as an object can transmit it.

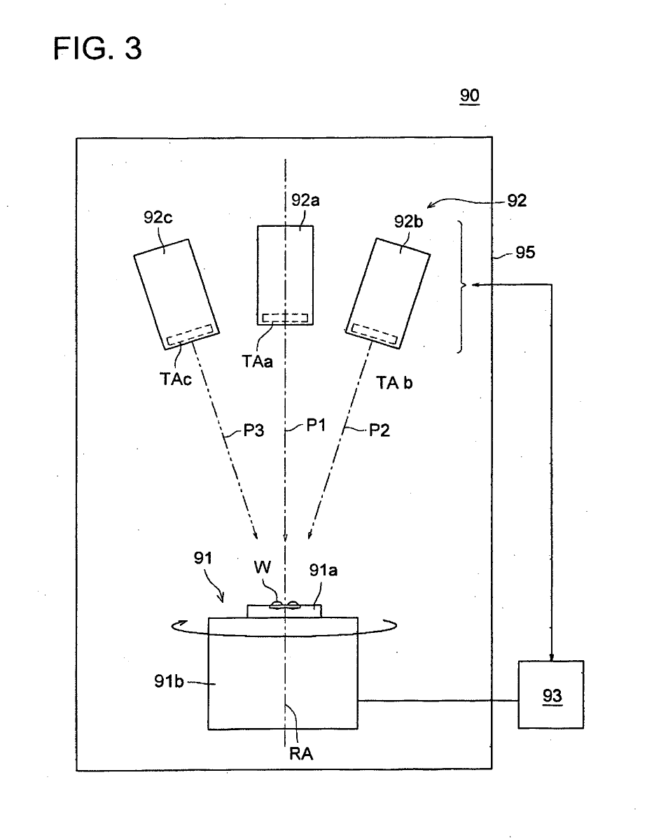

FIG. 3 is a view for conceptually illustrating the apparatus for film-forming the reflection prevention coat 53 shown in FIG. 2 (a), (b). This film formation apparatus 90 is a spattering type film formation apparatus, and has a substrate holding device 91, film material injection section 92, and control device 93. Hereupon, in them, the substrate holding device 91, and film material injection section 92 are housed in a vacuum casing 95 by which the film can be formed under low pressure gas atmosphere.

Herein, the substrate holding device 91 comprises a chuck 91a which holds a work W which is a base material of the composite objective lens 20, and is rotated together with the work W, and a rotation mechanism 91b which rotates the chuck 91a around the a rotation shaft RA at a desired speed. The film material injection section 92 has 3 different target units 92a, 92b and 92c for the purpose of forming a plurality of kinds of thin films successively. These target units 92a, 92b and 92c are not precisely shown in the drawings, however, they are symmetrically arranged around the rotation shaft RA of the substrate holding device 91. Each of target units 92a, 92b and 92c respectively houses a different kind of target TAa, TAb and TAc, formed of different film formation materials, and respectively generates particles of corresponding film formation material. Such a film formation particle is injected from target TAa, TAb, TAc, flies almost along the axis line P1, P2, P3 and its periphery, and comparatively uniformly enters on the whole of upper surface of the work W. Hereupon, each of target TAa, TAb and TAc are respectively formed of the low refractive index material, high refractive index material and middle refractive index material, forming the above reflection prevention coat 53. When the film material injection section 92 is moved and the film formation is conducted, the substrate holding device 91 rotates the work W fixed to the chuck 91a around the rotation shaft RA, and the film thickness of the thin film piled on the upper surface of the work W is equalized. Further, when, on the upper surface of the work, the low refractive index material, high refractive index material and middle refractive index material are successively film-formed, under the control of the control device 93, while moving targets TAa, TAb and TAc are switched, the film material whose composition and refractive index are different, is successively supplied.

Hereupon, the film formation device 90 of FIG. 3 is simply an exemplification, and the reflection prevention coat 53 shown in FIG. 2(a) and FIG. 2(b), can be film-formed by each kind of film formation method including the vacuum evaporation method, CVD method, atmospheric pressure plasma method.

The holder member 30 is a part molded of the plastic material same as, for example, the composite objective lens 20, and on the upper surface 30a, a part of the second lens part 22 side of the composite objective lens 20 is supported. The holder member 30 has an aperture 31, and by the edge part of the aperture 31, a circular part 32c that is the second lens part 22 periphery, is supported. The edge part of the aperture 31 and the circular part 32c of the second lens part 22, are mutually fixed, for example, by the UV hardening type adhesive agent, and the composite objective lens 20 can be fixed in a aligned condition to the holder member 30. Hereupon, the shape of the aperture 30 can be flexibly designed within the range that it does not disturb the supporting of the circular part 32c and does not interfere with the lower surface 22a of the second lens part 22, and step differences which simplifies the alignment of the composite objective lens 20 can be provided. Because in many cases, the holder member 30 is heated by the heat generation of the actuator section 71, it is desired that it is formed of the material having low heat-conductivity so as to lower the heat conducting to the composite objective lens 20, and that it is formed of the heat-resistant material whose thermal expansion coefficient is small so that it is prevented that the drive accuracy is lowered by the thermal deformation.

The actuator section 71 is composed of a coil which is fixed to the holder member 30 or integrated with the holder member 30, and by mutual action with another actuator part (not shown) composed of magnet, the holder member 30 can be minutely displaced in the focus direction along the optical axes OA1, OA2, or track direction perpendicular to the optical axes OA1, OA2. Further, the actuator section 71 can move largely the holder section 30 together with the first and the second lenses 21, 22, by the mutual action with the actuator part composed of magnet, not shown, in AB direction in the surface in which both lens parts 21, 22 are arranged, and the positions of both lens parts 21, 22, are selectively switched on the single optical path for object pick-up, and can be arranged.

As can be clearly seen from the above description, in the objective lens unit 10 of the present embodiment, the composite objective lens 20 in which the first lens part 21 and the second lens part 22 whose specifications are different, are arranged in an adjoining manner, is used. Hereby, when any one of the first and second lens parts 21, 22, is movably arranged on the optical path, on the information recording surface of BD and the information recording surface of DVD, spots which are respectively adapted to the standard, can be formed. Further, in the case of the objective lens unit 10 of the present embodiment, on the first optical surface 21a of the first lens part 21 and the first optical surface 22b of the second lens part 22, because the common reflection prevention film adopted for the laser light having the first wavelength λ1 and the laser light having the second wavelength λ2, that is, the reflection prevention coat 53 is provided, the reflection prevention coat 53 can be collectively formed on the first lens part 21 and the second lens part 22. Hereby, in spite of that the first lens part 21 and the second lens part 22 are adjoined, the high accurate reflection prevention coat 53 can be formed on the both comparatively simply and in low cost.

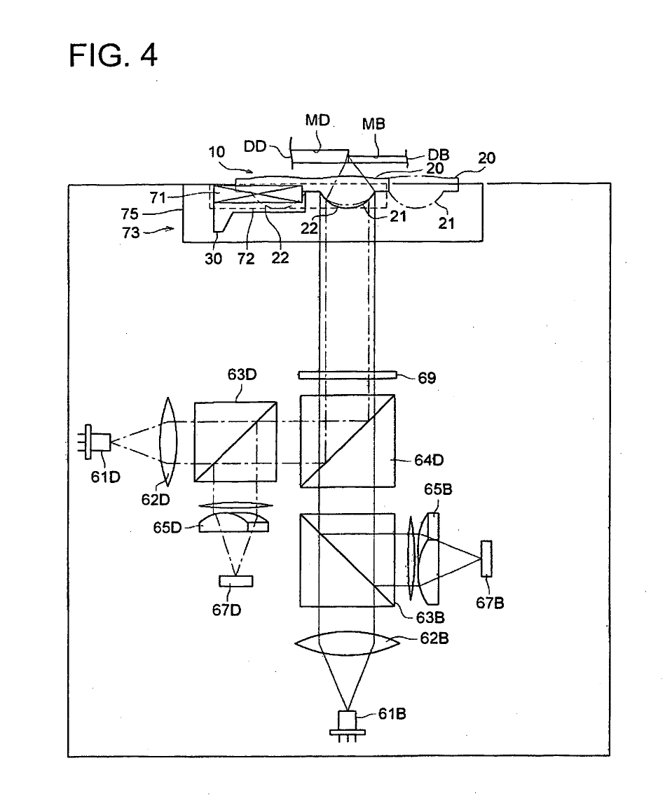

FIG. 4 is a view functionally showing the structure of the optical pick-up apparatus in which the objective lens unit 10 shown in FIG. 1 is mounted.

In this optical pick-up apparatus; the laser light from each of semiconductor lasers 61B, 61D is irradiated on optical disks DB, DD which are optical information recording media by using the common use objective lens unit 10, and reflection light from each of optical disks DB, DD, are guided to each of photo detectors 67B, 67D finally, through the common use objective lens unit 10. Hereupon, other than the above semiconductor lasers 61B, 61D or photo detectors 67B, 67D, the optical system including the polarized beam splitters 63B, 63D, 64D, cylindrical; lenses 65B; 65D, ¼ wavelength plate 69, function as the optical apparatus for conducting the reproducing and/or recording on each of optical disks DB, DD.

Herein, the first semiconductor laser 61B generates the first laser light (for example, the wavelength 405 nm for BD), this first laser light is converged by the first lens part 21 of the objective lens unit 10 which is at the first operating position (solid line), and a spot corresponding to NA 0.85 is formed on the information recording surface MB. The second semiconductor laser 61D generates the second laser light (for example, the wavelength 655 nm for DVD) for information reproducing, and after that, the second laser light is converged by the second lens part 22 of the objective lens unit 10 which is at the second operating position (a one-dotted chain line), and a spot corresponding to NA 0.65 is formed on the information recording surface MD. On the one hand, the first photo detector 67B detects the information recorded in the first optical disk DB as the photo signal (for example, the wavelength 405 nm for BD), and the second photo detector 67D detects the information recorded in the second optical disk DD, as the photo signal (for example, wavelength 655 nm for DVD). Hereupon, when the light source is switched from the first semiconductor laser 61B to the second semiconductor laser 61D, the objective lens unit 10 is slidingly moved, by the actuator 73 which is a drive device, (the position of one dotted chain line), and instead of the first lens part 21, the second lens part 22 is arranged on the optical path.

The detailed structure or specific movement of the optical pick-up apparatus of FIG. 4 will be described below. Initially, when the first optical disk DB is reproduced, the first laser light having the first wavelength λ1=405 nm is projected from the first semiconductor laser 61B, and the projected light flux becomes the parallel light by the collimator lens 62B. This light flux, after it transmits the polarized beam splitters 63B, 64D, and ¼ wavelength plate 69, is converged on the information recording surface MB of the first optical disk DB by the corresponding first lens part 21 in the composite objective lens 20.

The light flux modulated and reflected by information pits on the information recording surface MB, transmits again the first lens part 21, incident on the polarized beam splitter 63B, and reflected here, the astigmatism is given by the cylindrical lens 65B, incident on the first photo detector 67B, by using its output signal, the read-out signal of the information recorded in the first optical disk DB, is obtained.

Further, focus detection or track detection is conducted by detecting the shape change of the spot on the first photo detector 67B, and a light amount change caused by the position change of the spot on the first photo detector 67B. According to this detection, the actuator 73 moves the composite objective lens 20, that is, the first lens part 21 in the optical axis direction so that the light flux from the first semiconductor laser 61B is image-formed on the information recording surface MB of the first optical disk DB. And the actuator 73 moves the first lens part 21 also in the perpendicular direction to the optical axis direction so that the light flux from the first semiconductor laser 61B is image-formed on a predetermined track. Hereupon, the actuator 73 to conduct the focusing and/or tracking, is composed of the first actuator section 71 fitted to the holder member 30 side of the objective lens unit 10, and the second actuator section 72 fitted to the support device 75 side, and is operated under the control of the control device, not shown.

Next, when the second optical disk DD is reproduced, the second laser light having the second wavelength λ2=655 nm is projected from the second semiconductor laser 61D, and the projected light flux becomes the parallel light flux by the collimator lens 62D. This light flux is, after it transmits the polarized beam splitter 63D, reflected by the polarized beam splitter 64D, and via ¼ wavelength plate 69, converged on the information recording surface MD of the second optical disk DD by the corresponding second lens part 22 in the composite objective lens 20.

The light flux modulated and reflected by information pits on the information recording surface MD, transmits again the second lens part 22, reflected by the polarized beam splitter 64D, incident on the polarized beam splitter 63D, and reflected here, the astigmatism is given by the cylindrical lens 65D, incident on the second photo detector 67D, and by using its output signal, the read-out signal of the information recorded in the second optical disk DD, is obtained.

Further, in the same as the case of the first optical disk DB, the shape change of the spot on the second photo detector 67D, the light amount change by the position change are detected, and focus detection or track detection is conducted, and by the actuator 73 attached to the objective lens unit 10, the composite objective lens 20, that is, the second lens part 22 is moved for focusing and tracking.

Hereupon, the above description is the description of the case where the information is reproduced from optical disks DB, DD, however, when the output of the semiconductor lasers 61B, 61D is adjusted, the information can also be recorded in the optical disks DB, DD.

### The Second Embodiment

The objective lens unit according to the second embodiment will be described below. Hereupon, the objective lens unit according to the second embodiment is a deformed one of the objective lens unit of the first embodiment, and for a part not particularly described, it is the same as the first embodiment.

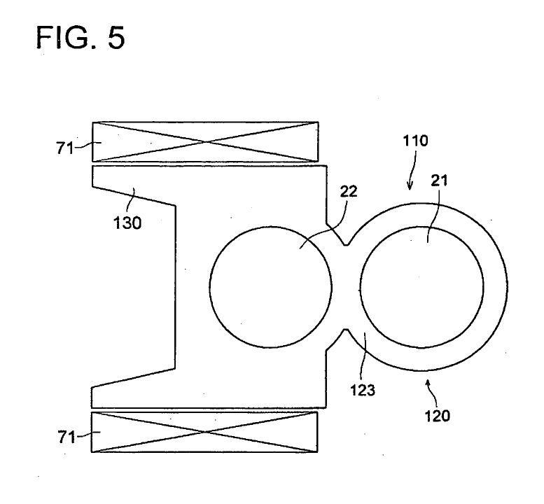

FIG. 5 is a plan view of the objective lens unit 110 of the present embodiment. In the objective lens unit 110 shown in the drawing, the connection part 123 of the composite objective lens 120 is a structure combined with the holder member 30 shown in FIG. 1. That is, in this case, the actuator section 71 is directly attached to the composite objective lens 120, and because the number of parts is reduced, and an adhering process of the composite objective lens to the holder is unnecessary, the cost reduction can be intended.

Hereupon, for each of lens parts 21, 22 of the composite objective lens 120, multi-layer film through which the object wavelengths of both are transmitted, is collectively formed.

### The Third Embodiment

The objective lens unit and the optical pick-up apparatus according to the third embodiment will be described below. Hereupon, the objective lens unit according to the third embodiment is a deformative example of the objective lens unit of the first embodiment, and for a part not particularly described, it is the same as the first embodiment.

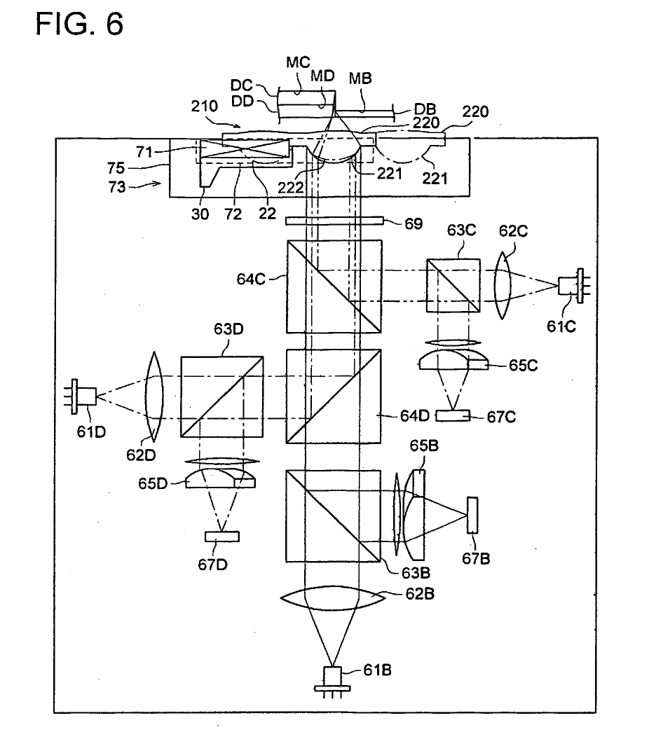

FIG. 6 is a view conceptually showing the structure of the optical pick-up apparatus in which the objective lens unit of the present embodiment is mounted.

In this optical pick-up apparatus, the laser light from each of semiconductor lasers 61B, 61D, 61C, are irradiated on optical disks DB, DD, DC which are optical information recording media, by using the common use objective lens unit 210, and the reflection light from each of optical disks DB, DD, DC, are guided finally to each of photo detectors 67B, 67D, 67C, through the common use objective lens unit 210. Hereupon, the optical system including the polarized beam splitters 63B, 63D, 64D, 64C, the cylindrical lenses 65B, 65D, ¼ wavelength plate 69, other than the above described semiconductor lasers 61B, 61D, 61C, or photo detectors 67B, 67D, 67C, functions as the optical apparatus for conducting the reproducing and/or recording of the information on each of optical disks DB, DD, DC.

Herein, for the optical apparatus for conducting the reproducing and/or recording of the information on the first optical disks DB, or the second optical disk DD, because it is the same as the case of the first embodiment, the description will be neglected below.

The third semiconductor laser 61C generates the third laser light (for example, the wavelength 780 nm for CD) for the information reproduction of the third optical disk DC, after that, the laser light is converged on the second lens part 222 of the objective lens unit 210 which is at the second moving position, and the spot corresponding to NA 0.53, is formed on the information recording surface MC. On the one hand, the third photo detector 67C detects the information recorded in the third optical disk DC as the optical signal (for example, the wavelength 780 nm for CD).

The detailed structure or specific movement of the optical pick-up apparatus of FIG. 6 will be described below. When the third optical disk DC is reproduced, the laser light having, for example, the wavelength 780 nm is projected from the third semiconductor laser 61C, and the projected light flux becomes the parallel light by the collimator lens 62C, after it transmits the polarized beam splitter 63C, reflected by the polarized beam splitter 64C, and it is converged on the information recording surface MC of the third optical disk DC by the corresponding second lens part 222 in the composite objective lens 220.

The light flux modulated and reflected by information pits on the information recording surface MC, transmits again the second lens part 222, reflected by the polarized beam splitter 64C, incident on the polarized beam splitter 63C, and reflected here, the astigmatism is given by the cylindrical lens 65C, incident on the third photo detector 67C, by using its output signal, the read-out signal of the information recorded in the third optical disk DC, is obtained.

Further, in the same as the case of the first and second optical disk DB, DD, the shape change of the spot on the third photo detector 67C, the light amount change by the position change are detected, and focus detection or track detection is conducted, and by the actuator 73, the objective lens unit 210, that is, the second lens part 222 is moved for focusing and tracking.

In the above 3 wavelength common use objective lens 210, in the first and second lens parts 221, 222, the common reflection prevention film is formed. That is, on the surface of the first lens part 21, for the first laser light having the wavelength λ1=405 nm, the second laser light having the wavelength λ2=655 nm, and the third laser light having the wavelength λ3=780 nm, the reflection prevention coat is provided. Hereupon, in the reflection prevention coat for both lens parts 221, 222, it is not necessary that it is accurate as described above, the coat can prevent the reflection for the laser light whose central wavelength is any one within the range of the wavelength λ1=390-420 nm, the coat can prevent the reflection for the laser light whose central wavelength is any one within the range of the wavelength λ2=630-680 nm, and the coat can prevent the reflection for the laser light whose central wavelength is any one within the range of the wavelength λ3=670-800 nm,

### The Fourth Embodiment

The objective lens unit and the optical pick-up apparatus according to the fourth embodiment will be described below. Hereupon, the objective lens unit according to the fourth embodiment is a deformative example of the objective lens unit of the first embodiment, and for a part not particularly described, it is the same as the first embodiment.

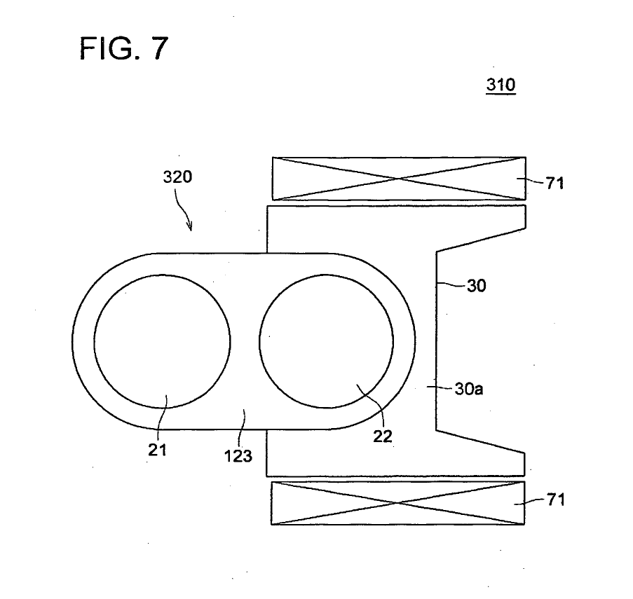

FIG. 7 is a plan view of the objective lens unit 310 of the present embodiment. In the objective lens unit 310 shown in the drawing, the connection part 123 constituting the composite objective lens 320 has an elliptical profile. Also in this case, the first lens part 21 is designed for use with the laser light having the wavelength 405 nm for BD, and the second lens part 21 is designed for use with the laser light having the wavelength 655 nm for DVD or the laser light having the wavelength 780 nm for CD. Further, when the connection part 123 of the second lens part 22 side in the composite objective lens 320 having the elliptical profile is adhered to the flat upper surface 30a of the holder member 30, the composite objective lens 320 is supported.

### The Fifth Embodiment

The objective lens unit according to the fifth embodiment will be described below. Hereupon, the objective lens unit according to the fifth embodiment is a deformed example of the objective lens unit of the first embodiment, and for a part not particularly described, it is the same as the first embodiment.

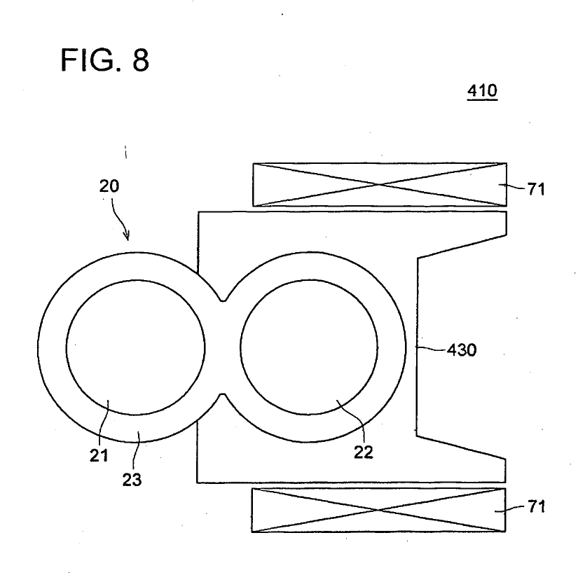

FIG. 8 is a plan view of the objective lens unit 410 of the present embodiment. In the objective lens unit 410 shown in the drawing, more than half of the connection part 23 provided to the composite objective lens 20 is adhered and supported on the upper surface 30a of the holder member 430. In this case, not only the connection part 23 constituting the periphery of the second lens part 22, but also a part (the second lens part 22 side) of the connection part 23 constituting the periphery of the first lens part 21, is supported by the holder member 430.

### The Sixth Embodiment

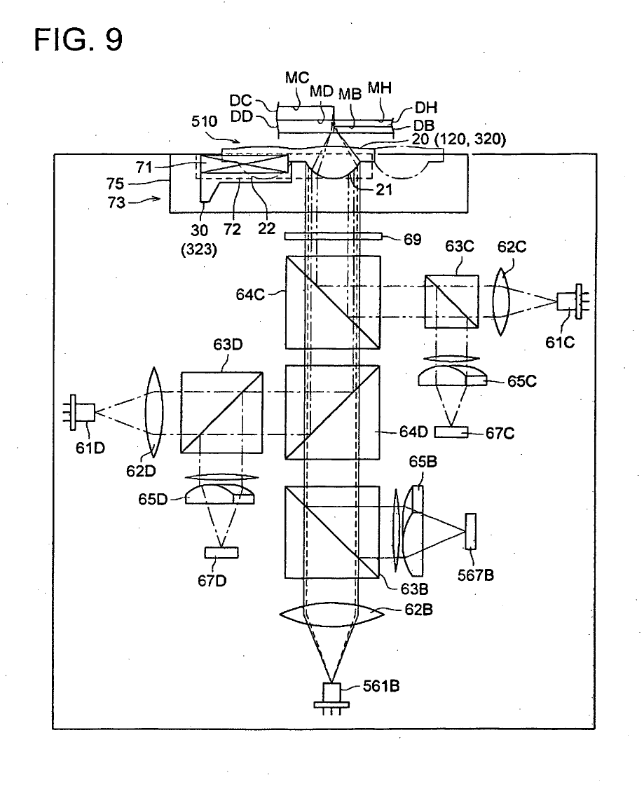

FIG. 9 is a view generally showing the structure of the optical pick-up apparatus according to the sixth embodiment. Hereupon, in the optical pick-up apparatus shown in the drawing, the objective lens unit 510 has the same structure as the objective lens unit 10 shown in FIG. 1, or the objective lens unit 310, 410 shown in FIG. 7, 8, however, the second lens part 22 is designed for use with not only the laser light having the wavelength 655 nm for DVD, or the laser light having the wavelength 780 nm for CD, but the laser light having the wavelength 405 nm for HD-DVD.

In this optical pick-up apparatus, the laser light from the semiconductor lasers 61B, 61D, 61C, are irradiated on the optical disks DB, DD, DC, DH, which are optical information recording media, by using the common use objective lens unit 510, and the reflection light from each of optical disks DB, DD, DC, DH, is finally guided to the photo detectors 67B, 67D, 67C, through the common use objective lens unit 510.

Herein, the first semiconductor laser 561B generates the first laser light (for example, the wavelength 405 nm for BD), for the information reproduction of the first optical disk DB, this laser light is converged on the first lens part 21 of the objective lens unit 510 which is at the first moving position, and a spot corresponding to NA 0.85 is formed on the information recording surface MB. Further, the first semiconductor laser 461B is combined with the light source of the fourth optical disk DH, and generates the laser light for the information reproduction (for example, the wavelength 405 nm for HD-DVD) of the fourth optical disk DH, and this laser light is converged on the second lens part 22 of the objective lens unit 510 which is at the second moving position, and a spot corresponding to NA 0.65 is formed on the information recording surface MH.

When the first optical disk DB is reproduced, the laser light having, for example, the wavelength 405 nm is projected from the first semiconductor laser 561B, and the projected light flux, after it transmits the polarized beam splitters 63B, 64D, 64C, is converged on the information recording surface MB of the first optical disk DB by the first lens part 21. The light flux modulated and reflected by information pits on the information recording surface MB, transmits again the first lens part 21, incident on the polarized beam splitter 63B, and reflected here, the astigmatism is given by the cylindrical lens 65B, incident on the first photo detector 567B, by using its output signal, the read-out signal of the information recorded in the first optical disk DB, is obtained.

On the one hand, when the fourth optical disk DH is reproduced, the laser light having, for example, the wavelength 405 nm is projected from the first semiconductor laser 561B, and the projected light flux, after it transmits the polarized beam splitters 63B, 64D, 64C, is converged on the information recording surface MH of the fourth optical disk DH by the second lens part 22. The numerical aperture in this case is 0.65, and the spot diameter is about 0.53 μm. The light flux modulated and reflected by information pits on the information recording surface MH, transmits again the second lens part 22, incident on the polarized beam splitter 63B, and reflected here, the astigmatism is given by the cylindrical lens 65B, incident on the first photo detector 567B, by using its output signal, the read-out signal of the information recorded in the fourth optical disk DH, is obtained.

When the first optical disk DB or the fourth optical disk DH is reproduced, the shape change of the spot on the second photo detector 67D, the light amount change by the position change are detected, and the focus detection or track detection is conducted, and by the actuator 73 attached to the objective lens unit 510, the composite objective lens 20, that is, the first lens part 21, or second lens part 22 is moved for focusing and tracking. Hereupon, when the fourth optical disk DH is reproduced, there is also a case where the control of the tilt angle of the composite objective lens 20 is necessary. In this case, a coil for the tilt control is provided to the actuator 73.

Hereupon, the above description is a description when the information is reproduced from the optical disk DB, DD, DC, DH, however, when the output of the semiconductor lasers 61B, 61D, 61C is adjusted, the information can also be recorded in the optical disks DB, DD, DC, DH.

In the optical pick-up apparatus according to the above-described sixth embodiment, the laser light for BD, and HD-DVD is projected from the first semiconductor laser 561B, however, 2 LD chips are provided in the first semiconductor laser 561B, and the laser light for BD and the laser light for HD-DVD can be generated separately. In this case, 2 sensor chips are provided also in the first photo detector 567B, and the laser light for BD and the laser light for HD-DVD can be separately detected. Further, the semiconductor laser for HD-DVD is exclusively provided, the light flux can be converged on the information recording surface MH of the fourth optical disk DH in another optical path from the first semiconductor laser 561B, and the returning light from the fourth optical disk DH can be separately detected by the exclusive sensor for HD-DVD.

In the above objective lens unit, because the objective lens is an integral one in which the first lens part and the second lens part are arranged in the adjoining manner, depending on which one of the first lens part and the second lens part is arranged on optical path, the reproducing and/or recording of the information can be simply conducted on 2 kinds of optical information recording media in which the standard of spot diameter on the information recording surface is different. Furthermore, in the case of the present objective lens unit, because the holder supports the part of the second lens part side in which the comparatively large second spot diameter is possible in the objective lens, even when the holder is heated by the tracking coil or focusing coil, the influence of heating is hardly exerted on the first lens part. Accordingly, the first lens part for which the requirement level for the circumstance of use is generally elevated, can be operated under comparatively advantageous circumstance, and the comparatively small first spot diameter can be surely maintained, and the high image forming accuracy can be secured.

### The Seventh Embodiment

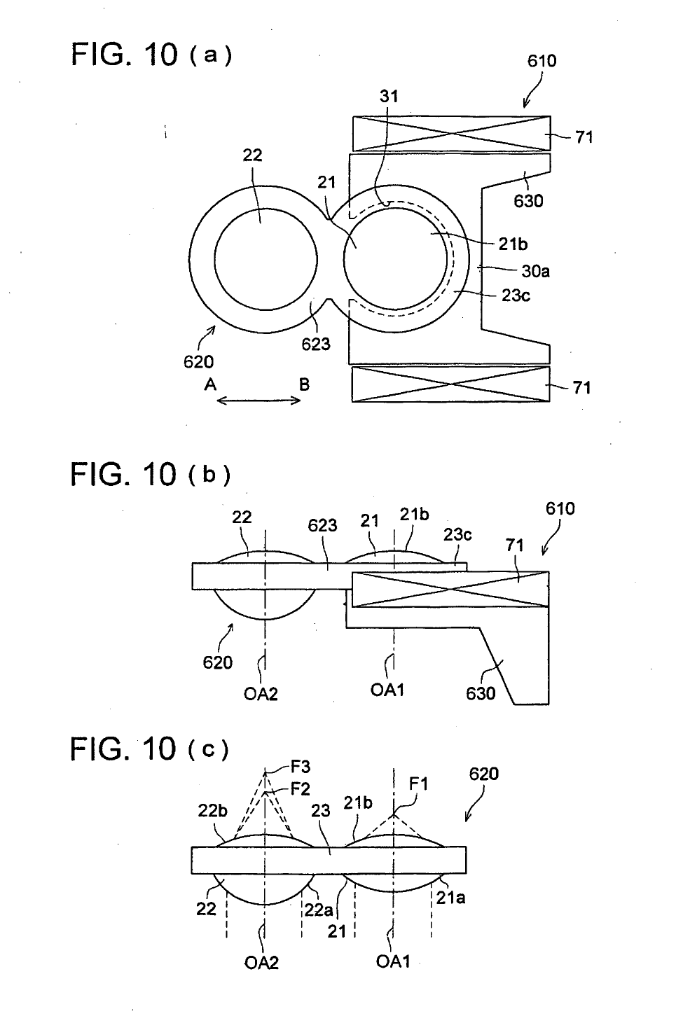

Referring to the drawings, the objective lens unit according to the seventh embodiment of the present invention, will be described below. Hereupon, the objective lens unit according to the seventh embodiment is a deformed example of the objective lens unit of the first embodiment, and for a part not particularly described, it is the same as the first embodiment. FIGS. 10(a) and (b) are plan view and side view for explaining the objective lens unit according to the seventh embodiment, and FIG. 10(c) is a side view of the composite objective lens constituting the objective lens unit.

The second lens part 22 is designed for use with the laser light having the wavelength 655 nm for DVD or wavelength 780 nm for CD. That is, as shown in FIG. 10(c), when the light flux of the laser light having wavelength 655 nm parallel to the optical axis OA2 is incident from the lower surface 22a side of the second lens part 22, the laser light flux of the wavelength 655 nm is projected from the upper surface 22b side of the second lens part 22, and this laser light flux is converged at the focal position F2 on the optical axis OA2, and forms a comparatively small light converging spot here. Further, when the light flux of the laser light having wavelength 780 nm parallel to the optical axis OA2 is incident from the lower surface 22a side of the second lens part 22, the laser light flux of the wavelength 780 nm is projected from the upper surface 22b side of the second lens part 22, and this laser light flux is converged at the focal position F3 on the optical axis OA2, and forms a comparatively small light converging spot here.

Hereupon, in the second lens part 22, on the lower surface 22a or upper surface 22b, the diffractive structure, or step structure can be formed, further, an area on which the laser light flux of the wavelength 655 nm for DVD is incident, and an area on which the laser light flux of the wavelength 780 nm for CD is incident, can be set to the different area. Hereby, the interval between a pair of focal positions F2, F3 on the optical axis OA2 can be flexibly changed and adjusted.

The holder member 630 is a part molded of the plastic material in a same manner as, for example, the composite objective lens 620, and on the upper surface 30a, a part of the first lens part 21 side in the composite objective lens 620 is supported. The holder member 630 has an aperture 31, and by the edge part of the aperture 31, a circular part 23c that is the first lens part 21 periphery, is supported. The edge part of the aperture 31 and the circular part 23c of the first lens part 21, are mutually fixed, for example, by the UV hardening type adhesive agent, and the composite objective lens 620 can be fixed in a aligned condition to the holder member 630. Hereupon, the shape of the aperture 30 can be flexibly designed within the range that it does not disturb the supporting of the circular part 23c and does not interfere with the lower surface 21a of the first lens part 21, and step differences which simplifies the alignment of the composite objective lens 620 can also be provided. Because in many cases, the holder member 30 is heated by the heat generation of the actuator section 71, it is desired that the holder part 630 is formed of the material having low heat-conductivity so as to lower the heat conducting to the composite objective lens 620, and that it is formed of the heat-resistant material whose thermal expansion coefficient is small so that it is prevented that the drive accuracy is lowered by the thermal deformation.

In this objective lens unit 10, by the position control of the holder member 30, under the condition that the first lens part 21 is arranged at the movement position on the optical path for the pick-up, when the laser light having the wavelength 405 nm for BD is made incident from the light source side on this first lens part 21, the laser light via the first lens part 21, is converged on the information recording surface of BD (corresponding to the focal position F1) so that it forms comparatively small spot diameter with comparatively large numerical aperture 0.85. On the one hand, in this objective lens unit 10, under the condition that the second lens part 22 is arranged on the optical path by the position control of the holder member 30, when the laser light having the wavelength 655 nm for DVD is made incident from the light source side on the second lens part 22, the laser light via the second lens part 22, is converged on the information recording surface of DVD (corresponding to the focal position F1) so that it forms comparatively large spot diameter with comparatively small numerical aperture 0.65. Further, under the condition that the second lens part 22 is arranged on the optical, when the laser light having the wavelength 780 nm for CD is made incident from the light source side on the second lens part 22, the laser light via the second lens part 22, is converged on the information recording surface of CD (corresponding to the focal position F1) so that it forms further large spot diameter with further small numerical aperture 0.53.

In the objective lens unit 610 of the present embodiment, because the composite objective lens 20 in which the first lens part 21 and the second lens part 22 whose specifications are different, are arranged in a adjoining manner, is used, when any one of the first and second lens parts 21, 22, is moving-arranged on the optical path, on the iand, in this objecng surface of BD and the information recording surface of DVD, or CD, spots which are respectively adapted to the standard, can be formed. In this case, the spot diameter formed on the information recording surface of BD by the first lens part 21, is about 0.41 μm, and the spot diameters formed on the information recording surface of DVD or CD by the second lens part 22, are respectively about 0.87, 1.2 μm. In the case of the objective lens unit 610 of the present embodiment, because the holder member 630 is connected to the first lens part 21 side which can forms comparatively small spot diameter (for BD) in the composite objective lens 620, the first lens part 21 can be arranged in the proximity to the holder member 630 which is the drive object when the tracking or focusing. Hereby, the first lens part 21 can be precisely dislocated together with the holder member 30. That is, the first lens part 21 for which the requirement level is high for the circumstance of use can be operated under comparatively advantageous circumstance for the position control, and because the light flux of the comparatively small first spot diameter formed by the laser light having wavelength 405 nm for BD, can be accurately incident on the target position, the reproducing and/or recording of the information can be high accurately conducted.

The present invention is described following the embodiments as above, however, the present invention is not limited to the above embodiments, but, various deformations are possible. For example, in the above first and third embodiments, the reproducing and/or recording of the information is conducted for BD by the first lens part 21, 321, and the reproducing and/or recording of the information is conducted for DVD or CD by the second lens part 22, 222, however, the reproducing and/or recording of the information is conducted for HD-DVD by the first lens part 21, and the reproducing and/or recording of the information can also be conducted for DVD or CD by the second lens part 22.

Further, the reproducing and/or recording of the information is conducted for DVD by the first lens part 21, and the reproducing and/or recording of the information can also be conducted for CD by the second lens part 22. In this case, for the first and second lens parts 21, 22, in the wavelength λ2=630-680 nm or the wavelength λ3=670-800 nm, consequentially, 630-800 nm and in common, the reflection prevention coat having the reflection prevention function is coated.

Further, it is not limited that the composite objective lens 20 has 2 lens parts 21, 22, but can have 3 or more lens parts, in this case, each of lens parts forms the reflection prevention film having the reflection prevention function for the wavelengths of the all laser light which are object.

What is claimed is:

1. An objective lens unit for use in an optical pick-up apparatus comprising:
a first lens part used in a light having a first wavelength;
a second lens part which is used in a light having a second wavelength different from the first wavelength;
wherein the first lens part and the second lens part are integrated in an adjoining manner; and
a common reflection prevention film adequate for both the light having the first wavelength and the light having the second wavelength that is provided on an optical surface of the first lens part and an optical surface of the second lens part.

2. The objective lens unit of claim 1, further comprising;
a connection part which the first lens part and the second lens part are mutually positioned and held.

3. The objective lens unit of claim 1, wherein the first wavelength is within the range of 390-420 nm.

4. The objective lens unit of claim 1, wherein the second wavelength is within the range of 630-680 nm.

5. The objective lens unit of claim 1, wherein the second wavelength is within the range of 670-800 nm.

6. The objective lens unit of claim 1, further comprising:
a holder for directly or indirectly supporting at least one of the first lens part and the second lens part.

7. An optical pick-up apparatus comprising:
(a) an objective lens unit including;
(i) a first lens part used in a light having a first wavelength; and
(ii) a second lens part which is used in a light having a second wavelength different from the first wavelength;
wherein the first lens part and the second lens part are integrated in an adjoining manner; and
wherein a common reflection prevention film adequate for both the light having the first wavelength and the light having the second wavelength is provided on an optical surface of the first lens part and an optical surface of the second lens part; and
(b) an optical device which reads or writes information in or on a first optical information recording medium through the first lens part and which reads or writes information in or on a second optical information recording medium through the second lens part.

8. The optical pick-up apparatus of claim 7, further comprising a drive device by which the objective lens unit is driven and the first and second lens parts are displaced.

9. A method for manufacturing an integral type objective lens unit in which a first lens part used for a light having a first wavelength and a second lens part used for a light having a second wavelength different from the first wavelength, are arranged in an adjoining manner, comprising step of:
forming common reflection prevention film, adequate for both the light having the first wavelength and the light having the second wavelength, on an optical surface of the first lens part and an optical surface of the second lens part.

10. The objective lens unit of claim 6, wherein the holder supports the second lens part side.

11. The objective lens unit of claim 1, wherein a numerical aperture of the first lens part is larger than a numerical aperture of the second lens part.

12. The objective lens unit of claim 10, wherein the first lens part, second lens part and the holder are integrally molded.

13. The optical pick-up apparatus of claim 7, further comprising a holder for directly or indirectly supporting the second lens part side of the objective lens unit.

14. The optical objective lens unit of claim 6, wherein the holder supports the first lens part side.

15. The objective lens unit of claim 14, wherein the holder supports the second lens part side.

16. The objective lens unit of claim 15, wherein the first lens part, second lens part and the holder are integrally molded.

17. The optical pick-up apparatus of claim 12, further comprising a holder for indirectly supporting the second lens part side of the objective lens unit.
